(19) United States
(12) Patent Application Publication
(10) Pub. No.: US 2026/0331708 A1
(43) Pub. Date: Oct. 22, 2026

(54) SECONDARY BATTERY AND BATTERY ASSEMBLY

(71) Applicant: Prime Planet Energy & Solutions, Inc., Tokyo (JP)

(72) Inventor: Sayaka KAWAGUCHI, Akashi-shi (JP)

(21) Appl. No.: 19/634,069

(22) Filed: Mar. 31, 2026

(30) Foreign Application Priority Data
Apr. 2, 2025 (JP) 2025-061239

(51) Int. Cl. H01M 50/477; H01M 50/209; H01M 50/289; H01M 50/474

(52) U.S. Cl. CPC H01M 50/477; H01M 50/209; H01M 50/289; H01M 50/474

(57) ABSTRACT

A spacer has a pair of first portions located on both end sides of the spacer in the second direction and a second portion located between the pair of first portions in a second direction, a flat surface of the spacer is formed continuously from one of the pair of first portions to the other of the pair of first portions, and at least a portion of each of the pair of first portions in a first direction has a larger thickness than a thickness of the second portion in a direction orthogonal to the flat surface.

### CROSS REFERENCE TO RELATED APPLICATIONS

This nonprovisional application is based on Japanese Patent Application No. 2025-061239 filed on Apr. 2, 2025 with the Japan Patent Office, the entire contents of which are hereby incorporated by reference.

### BACKGROUND OF THE INVENTION

### Field of the Invention

The present technology relates to a secondary battery and a battery assembly.

### Description of the Background Art

Japanese U.S. Pat. No. 4,537,353 discloses a prismatic battery in which a positive electrode terminal is provided on a side surface of a battery case on one side and a negative electrode terminal is provided at an end portion of the battery case on the other side.

### SUMMARY OF THE INVENTION

It has been required to suppress precipitation of metal in a secondary battery. When a battery assembly is formed from secondary batteries each having an exterior container having a prismatic shape, a pressure load is likely to be relatively small in the vicinity of an end side of a surface of the exterior container having a substantially rectangular shape. Due to variation in the pressure load, a resistance difference is caused in the electrode assembly, thereby facilitating occurrence of the precipitation of metal. It has been required to effectively suppress the precipitation of metal at a portion at which the pressure load is relatively small. From this viewpoint, there is still room for improvement in a conventional secondary battery.

An object of the present technology is to provide: a secondary battery in which precipitation of metal is suppressed; and a battery assembly including the secondary battery.

The present technology provides the following secondary battery and the following battery assembly.

[1] A secondary battery comprising: an electrode assembly having a pair of main surfaces; a spacer having a flat surface facing one of the pair of main surfaces; and an exterior container that has a prismatic shape and that accommodates the electrode assembly and the spacer, wherein the exterior container has a pair of first surfaces respectively facing the pair of main surfaces, a pair of second surfaces substantially orthogonal to the first surfaces, and a pair of third surfaces substantially orthogonal to the first surfaces and the second surfaces, and an area of each of the first surfaces is larger than each of an area of each of the second surfaces and an area of each of the third surfaces, the first surface has a substantially rectangular shape including a pair of first end sides each extending in a first direction and a pair of second end sides each extending in a second direction substantially orthogonal to the first direction, and the pair of first end sides are longer than the pair of second end sides, the spacer includes a pair of first portions located on both end sides of the spacer in the second direction, and a second portion located between the pair of first portions in the second direction, the flat surface of the spacer is formed continuously from one of the pair of first portions to the other of the pair of first portions, and at least a portion of each of the pair of first portions in the first direction has a larger thickness than a thickness of the second portion in a direction orthogonal to the flat surface.

[2] The secondary battery according to [1], wherein at least a central portion of each of the pair of first portions in the first direction has a larger thickness than the thickness of the second portion in the direction orthogonal to the flat surface.

[3] The secondary battery according to [1] or [2], wherein an entire region of each of the pair of first portions in the first direction has a larger thickness than the thickness of the second portion in the direction orthogonal to the flat surface.

[4] The secondary battery according to any one of [1] to [3], wherein the spacer reaches outside of the electrode assembly in the second direction.

[5] The secondary battery according to any one of [1] to [4], further comprising an insulating member provided outside the electrode assembly.

[6] A battery assembly comprising: a plurality of the secondary batteries according to any one of [1] to [5], the plurality of the secondary batteries being arranged side by side in a third direction orthogonal to the first direction and the second direction; and an inter-cell separator provided between the plurality of the secondary batteries, wherein an area of the inter-cell separator is smaller than an area of each of the first surfaces of the exterior container as viewed in the third direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to an embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a diagram showing a state in which the secondary battery shown in FIG. 1 is viewed in a direction of arrow V.

FIG. 6 is a front cross sectional view of the secondary battery shown in FIG. 1.

FIG. 7 is a cross sectional view of a negative electrode plate.

FIG. 8 is a front view showing the negative electrode plate.

FIG. 9 is a cross sectional view of a positive electrode plate.

FIG. 10 is a front view showing the positive electrode plate.

FIG. 11 is a perspective view showing a state of attaching a sealing plate to a current collector on the positive electrode side.

FIG. 12 is a perspective view showing the configuration of the secondary battery.

FIG. 13 is a diagram of the secondary battery and an inter-cell separator adjacent to the secondary battery as viewed in a stacking direction.

FIG. 14 is a diagram for illustrating a flat surface of a stacked type electrode assembly.

FIG. 15 is a diagram for illustrating a flat surface of a wound type electrode assembly.

FIG. 16 is a cross sectional view of the electrode assembly and a spacer accommodated in an exterior container.

FIG. 17 is a cross sectional view showing an exemplary shape of the spacer adjacent to a main surface of the electrode assembly.

FIG. 18 is a cross sectional view showing another exemplary shape of the spacer adjacent to the main surface of the electrode assembly.

FIG. 19 is a cross sectional view showing still another exemplary shape of the spacer adjacent to the main surface of the electrode assembly.

FIG. 20 is a front view of the electrode assembly.

FIG. 21 is a front view showing a state in which the spacer is disposed on the main surface of the electrode assembly.

FIG. 22 is a front cross sectional view showing a state in which the electrode assembly and the spacer are inserted into a case main body.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

Moreover, sizes such as width, length, and diameter of each member illustrated in the present specification are not limited to those shown in the figures, and can be appropriately changed. In the present specification, ordinal numbers such as “first” and “second” may be given to respective configurations, but these ordinal numbers do not limit priority, order, or the like unless explicitly defined.

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode. Further, the term “electrode plate” may collectively represent a positive electrode plate and a negative electrode plate.

In the present specification, the “battery” can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

In the present specification, the X direction (first direction) may be referred to as a “width direction” of each of the secondary battery, the electrode assembly, and the case main body, the Z direction (second direction) may be referred to as a “height direction” of the secondary battery, the electrode assembly, and the case main body, and the Y direction (third direction) may be referred to as a “thickness direction” of the secondary battery, the electrode assembly, and the case main body.

### Overall Configuration of Secondary Battery

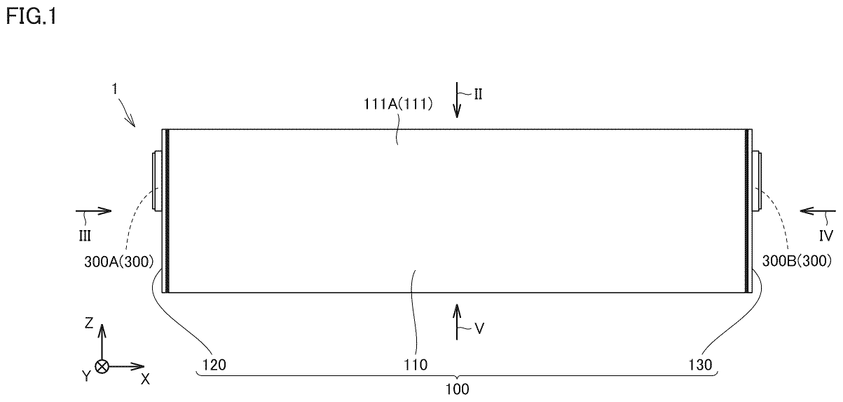

The overall configuration of a secondary battery 1 will be described with reference to FIGS. 1 to 6. Secondary battery 1 includes a case 100 (exterior container), an electrode assembly 200, electrode terminals 300, and current collectors 400. Case 100 includes a case main body 110, a sealing plate 120, and a sealing plate 130.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 including case 100 having a prismatic shape is obtained. Case main body 110 is composed of a metal. Specifically, case main body 110 is composed of aluminum, an aluminum alloy, iron, an iron alloy, or the like.

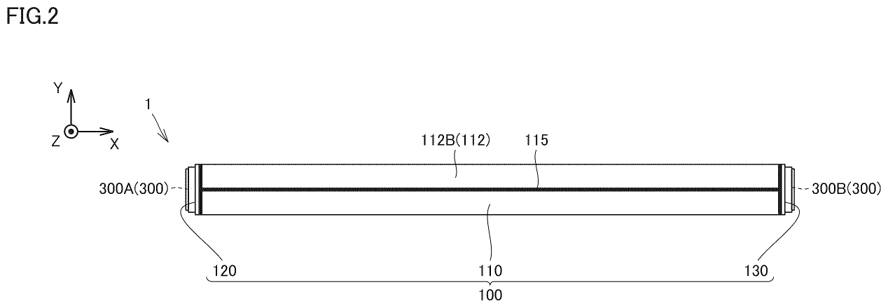

As shown in FIGS. 1 and 2, sealing plate 120 and sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, energy ray application such as laser welding is favorable). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 300 mm or more. In this way, secondary battery 1 can be formed to have a relatively large size (high capacity). The size (height) of case main body 110 in the Z direction is preferably about 100 mm or less. Thus, (low-height) secondary battery 1 having a relatively low height can be formed, thus resulting in improved ease of mounting on a vehicle, for example. However, the sizes of secondary battery 1 are not limited to the above ranges.

Case main body 110 includes first side surface portions 111 (first surfaces) and second side surface portions 112 (second surfaces). First side surface portions 111 are constituted of a pair of first side surface portions 111A, 111B, whereas second side surface portions 112 are constituted of a pair of second side surface portions 112A, 112B. First side surface portions 111A, 111B constitute parts of the side surfaces of case 100. The pair of second side surface portions 112A, 112B constitute the bottom surface portion and upper surface portion of case 100. First side surface portions 111 and second side surface portions 112 are provided to intersect each other. First side surface portions 111 and second side surface portions 112 are connected at their respective end portions.

As shown in FIG. 5, a gas-discharge valve 150 is provided in one second side surface portion 112A of second side surface portions 112. Gas-discharge valve 150 extends in the width direction (X direction) of secondary battery 1. Gas-discharge valve 150 extends from the center of case main body 110 in the X direction to such an extent that gas-discharge valve 150 does not reach both ends of case main body 110 in the X direction. The shape of gas-discharge valve 150 can be changed appropriately.

The thickness of the plate-shaped member in gas-discharge valve 150 is thinner than the thickness of the plate-shaped member of case main body 110 other than gas-discharge valve 150. Thus, when the pressure in case 100 becomes equal to or more than a predetermined value, gas-discharge valve 150 is fractured prior to the other portions of case main body 110, thereby discharging the gas in case 100 to the outside.

As shown in FIG. 2, joining portion 115 is formed at the other second side surface portion 112B of second side surface portions 112. Joining portion 115 extends in the width direction (X direction) of secondary battery 1. At joining portion 115, the end sides of the plate-shaped member constituting case main body 110 are joined to each other.

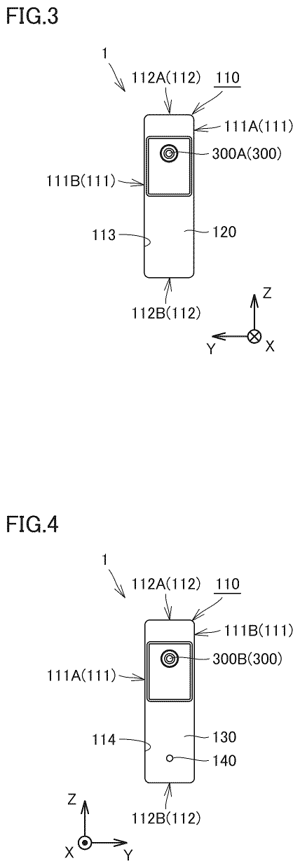

As shown in FIG. 3, an opening 113 (first opening) is provided at an end portion of case main body 110 on one side in the first direction (X direction). Opening 113 is sealed by sealing plate 120 (first sealing plate). Joining portion 115 is formed at opening 113 so as to seal opening 113. Each of opening 113 and sealing plate 120 has a substantially rectangular shape in which the Y direction corresponds to its short-side direction and the Z direction corresponds to its long-side direction. The substantially rectangular shape includes a rectangular shape or a generally rectangular shape such as a rectangular shape having corners each with a curvature.

A negative electrode terminal 300A is provided on sealing plate 120. The position of negative electrode terminal 300A can be appropriately changed.

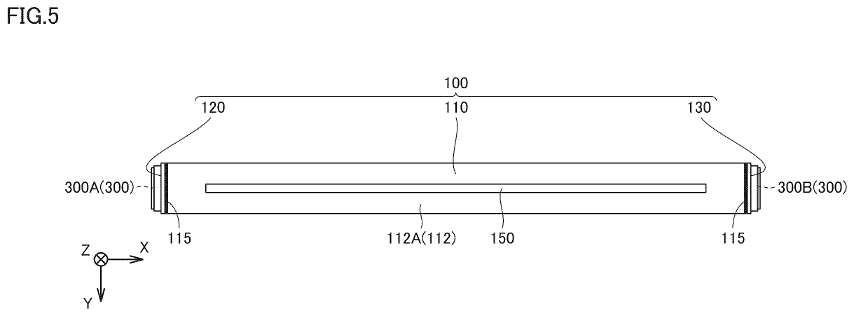

As shown in FIG. 4, an opening 114 (second opening) is provided at an end portion of case main body 110 on the other side in the X direction. That is, opening 114 is located at an end portion opposite to opening 113, and openings 113 and 114 face each other. Opening 114 is sealed by sealing plate 130 (second sealing plate). Joining portion 115 is formed at opening 114 so as to seal opening 114. Each of opening 114 and sealing plate 130 has a substantially rectangular shape in which the Y direction corresponds to its short-side direction and the Z direction corresponds to its long-side direction.

Sealing plate 130 is provided with a positive electrode terminal 300B and an injection hole 140. The positions of positive electrode terminal 300B and injection hole 140 can be appropriately changed. Injection hole 140 is sealed by a sealing member (not shown). As the sealing member, for example, a blind rivet or another metal member can be used.

Each of sealing plate 120 and sealing plate 130 is composed of a metal. Specifically, each of sealing plate 120 and sealing plate 130 is composed of aluminum, an aluminum alloy, iron, an iron alloy, or the like.

Sealing plates 120, 130 (third surfaces) constitute parts of case 100. Sealing plates 120, 130 are provided to intersect (provided to be substantially orthogonal to) first side surface portions 111 and second side surface portions 112.

In case 100, the area (first area) of each of the pair of first side surface portions 111 (first surfaces) is larger than each of the area (second area) of each of the pair of second side surface portions 112 (second surfaces) and the area (third area) of each of sealing plates 120, 130 (third surfaces).

Negative electrode terminal 300A is electrically connected to a negative electrode of electrode assembly 200. Negative electrode terminal 300A is attached to sealing plate 120, i.e., case 100. Positive electrode terminal 300B is electrically connected to a positive electrode of electrode assembly 200. Positive electrode terminal 300B is attached to sealing plate 130, i.e., case 100.

Negative electrode terminal 300A is composed of a conductive material (more specifically, a metal), and may be composed of, for example, copper or a copper alloy. Positive electrode terminal 300B is composed of a conductive material (more specifically, a metal), and may be composed of, for example, aluminum or an aluminum alloy.

Electrode assembly 200 is an electrode assembly having a flat shape and having a below-described negative electrode plate 210 and a below-described positive electrode plate 220 stacked on each other. Specifically, electrode assembly 200 is a stacked type electrode assembly in which a plurality of negative electrode plates 210 and a plurality of positive electrode plates 220 are alternately stacked with a separator being interposed therebetween. The separator may be formed by folding a strip-shaped insulating sheet member in a meandering manner, or may be formed by individually providing a plurality of divided insulating sheets. In the present specification, the “electrode assembly” is not limited to the stacked type electrode assembly, and may be a wound type electrode assembly in which a strip-shaped negative electrode plate and a strip-shaped positive electrode plate are wound together with a strip-shaped separator being interposed therebetween. The separator can be constituted of, for example, a microporous membrane composed of polyolefin.

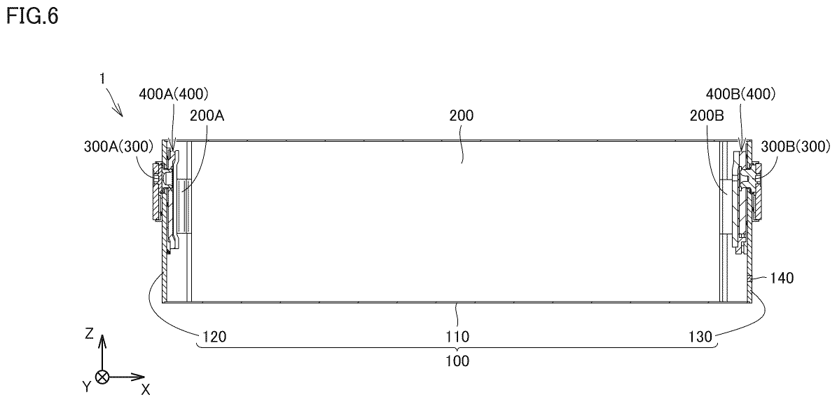

As shown in FIG. 6, case 100 accommodates electrode assembly 200. Electrode assembly 200 is accommodated in case 100 such that the long-side direction thereof is parallel to the X direction. Specifically, one or a plurality of the stacked type electrode assemblies and an electrolyte solution (electrolyte) (not shown) are accommodated in case 100. As the electrolyte solution (non-aqueous electrolyte solution), it is possible to use, for example, a solution obtained by dissolving LiPF₆ in a non-aqueous solvent. Instead of the electrolyte solution, a solid electrolyte may be used.

Electrode assembly 200 includes a main body portion having a substantially rectangular shape, a negative electrode tab group 200A, and a positive electrode tab group 200B.

The main body portion is constituted of below-described negative electrode plate 210 and below-described positive electrode plate 220. Negative electrode tab group 200A is located at an end portion of electrode assembly 200 on one side (the sealing plate 120 side) with respect to the main body portion thereof in the X direction. Positive electrode tab group 200B is located at an end portion of electrode assembly 200 on the other side (the sealing plate 130 side) with respect to the main body portion thereof in the X direction.

Each of negative electrode tab group 200A and positive electrode tab group 200B is formed to protrude from a central portion of electrode assembly 200 toward sealing plate 120 or sealing plate 130.

Current collectors 400 include a negative electrode current collector 400A and a positive electrode current collector 400B. Each of negative electrode current collector 400A and positive electrode current collector 400B is constituted of a plate-shaped member. Electrode assembly 200 is electrically connected to negative electrode terminal 300A and positive electrode terminal 300B through current collectors 400.

Negative electrode current collector 400A is disposed on sealing plate 120 with an insulating member composed of a resin being interposed therebetween. Negative electrode current collector 400A is electrically connected to negative electrode tab group 200A and negative electrode terminal 300A. Negative electrode current collector 400A is composed of a conductive material (more specifically, a metal), and can be composed of copper, a copper alloy, or the like, for example.

Positive electrode current collector 400B is disposed on sealing plate 130 with an insulating member composed of a resin being interposed therebetween. Positive electrode current collector 400B is electrically connected to positive electrode tab group 200B and positive electrode terminal 300B. Positive electrode current collector 400B is composed of a conductive material (more specifically, a metal), and can be composed of aluminum, an aluminum alloy, or the like, for example. Positive electrode tab group 200B may be electrically connected to sealing plate 130 directly or via positive electrode current collector 400B. In this case, sealing plate 130 may serve as positive electrode terminal 300B.

### Configuration of Electrode Assembly 200

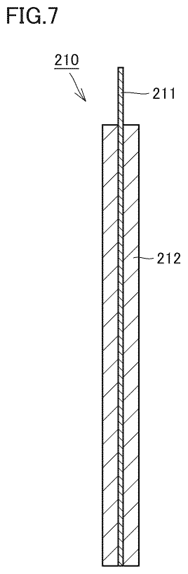

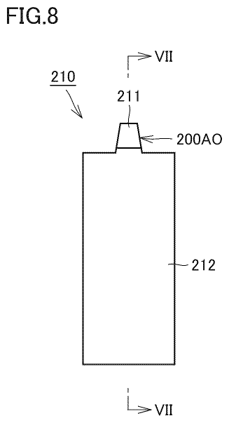

As shown in FIGS. 7 and 8, negative electrode plate 210 includes a negative electrode core body 211 and a negative electrode active material layer 212. A negative electrode tab 200A0 constituted of negative electrode core body 211 is provided at one end portion, in the width direction, of negative electrode plate 210. When negative electrode plates 210 are stacked, a plurality of negative electrode tabs 200A0 are stacked to form negative electrode tab group 200A. Negative electrode tab group 200A is electrically connected to the negative electrode. The length of each of negative electrode tabs 200A0 in the plurality of negative electrode plates 210 in the protruding direction is appropriately adjusted in consideration of the state in which negative electrode tab group 200A is connected to negative electrode current collector 400A. The shape of negative electrode tab 200A0 is not limited to the one illustrated in FIG. 8.

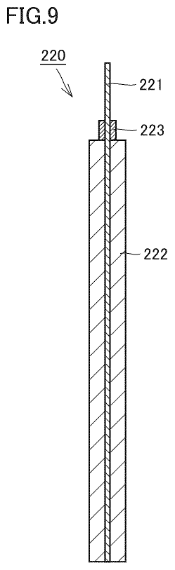

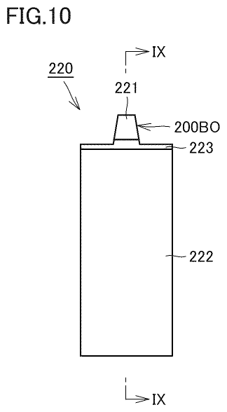

As shown in FIGS. 9 and 10, positive electrode plate 220 includes a positive electrode core body 221, a positive electrode active material layer 222, and a positive electrode protective layer 223. A positive electrode tab 200B0 constituted of positive electrode core body 221 is provided at one end portion, in the width direction, of positive electrode plate 220. When positive electrode plates 220 are stacked, a plurality of positive electrode tabs 200B0 are stacked to form positive electrode tab group 200B. Positive electrode tab group 200B is electrically connected to the positive electrode. The length of each of positive electrode tabs 200B0 in the plurality of positive electrode plates 220 in the protruding direction is appropriately adjusted in consideration of the state in which positive electrode tab group 200B is connected to positive electrode current collector 400B. The shape of positive electrode tab 200B0 is not limited to the one illustrated in FIG. 10.

Positive electrode protective layer 223 is provided at the root of positive electrode tab 200B0. Positive electrode protective layer 223 may not necessarily be provided at the root of positive electrode tab 200B0. (Accommodation of Electrode Assembly 200)

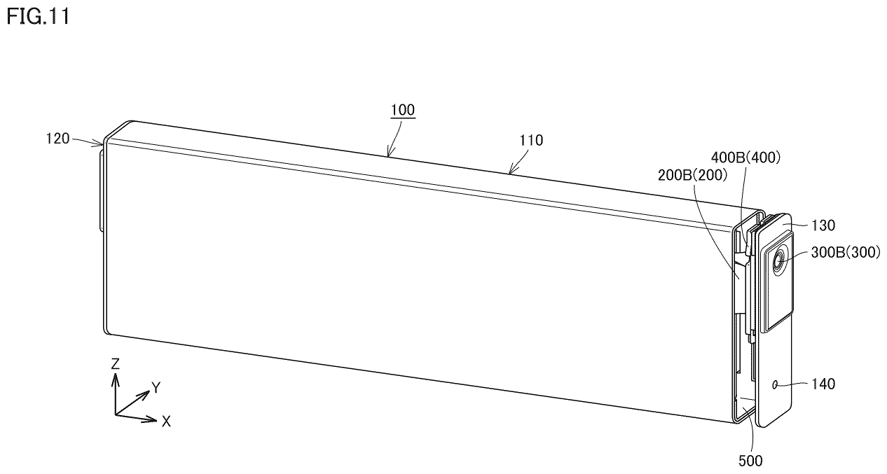

Electrode assembly 200 is inserted into case main body 110 from opening 113 with the positive electrode tab group 200B side being inserted first. As shown in FIG. 11, a spacer 500 is provided between electrode assembly 200 and sealing plate 130 located on the positive electrode side. A spacer 500 is also provided between electrode assembly 200 and sealing plate 120 located on the negative electrode side in the same manner as on the positive electrode side.

Before inserting electrode assembly 200 into case main body 110, electrode assembly 200 and negative electrode terminal 300A may be electrically connected to each other. After electrode assembly 200 is inserted into case main body 110, electrode assembly 200 is electrically connected to positive electrode terminal 300B.

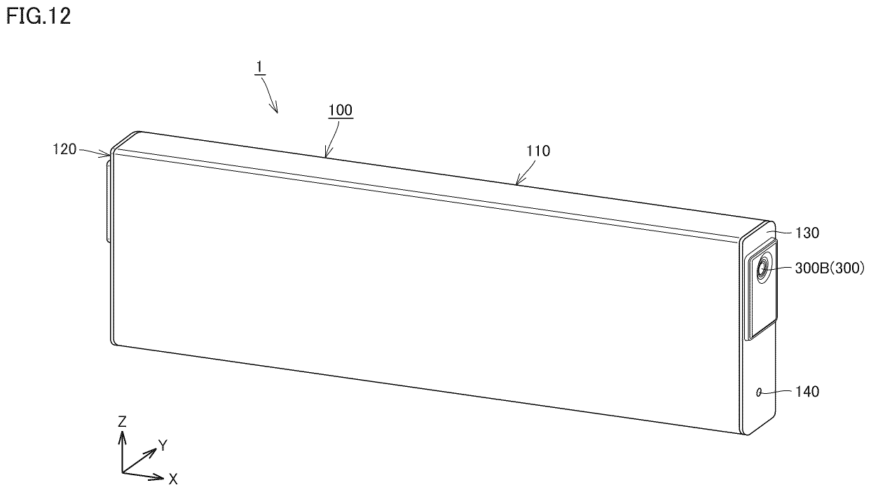

After electrode assembly 200 is inserted into case main body 110, sealing plate 120 and sealing plate 130 are joined to case main body 110 as shown in FIG. 12. Sealing plate 120 seals opening 113 of case main body 110, and sealing plate 130 seals opening 114 of case main body 110. In this way, electrode assembly 200 is accommodated in case main body 100.

### Configuration of Battery Assembly

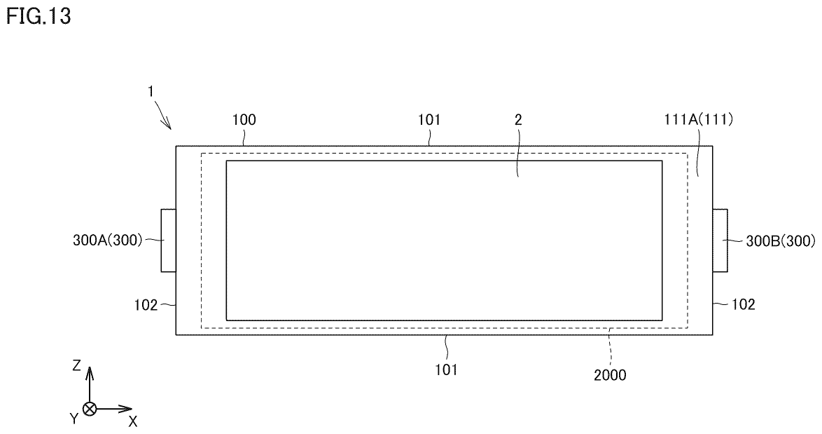

As shown in FIG. 13, first side surface portion 111 of case main body 110 has a substantially rectangular shape including a pair of first end sides 101 each extending in the X direction and a pair of second end sides 102 each extending in the Z direction. Here, each of the pair of first end sides 101 is longer than each of the pair of second end sides 102. That is, first side surface portion 111 has a substantially rectangular shape in which the X direction corresponds to the long-side direction thereof and the Z direction corresponds to the short-side direction thereof.

When forming a battery assembly, a plurality of secondary batteries 1 are arranged side by side in the Y direction. An inter-cell separator 2 is provided between the plurality of secondary batteries 1. As shown in FIG. 13, as viewed in the Y direction, the area of inter-cell separator 2 is smaller than the area of first side surface portion 111 of case main body 110. Preferably, the area of inter-cell separator 2 is smaller than the area of a flat surface 2000 of electrode assembly 200.

When electrode assembly 200 is the stacked type electrode assembly, flat surface 2000 is formed across the entire region of electrode assembly 200 as shown in FIG. 14.

When electrode assembly 200 is the wound type electrode assembly (with a winding axis extending in the X direction), flat surface 2000 is formed in a region other than circumferential portions formed at both end portions of electrode assembly 200 in the Z direction as shown in FIG. 15.

### Configuration of Spacer 600

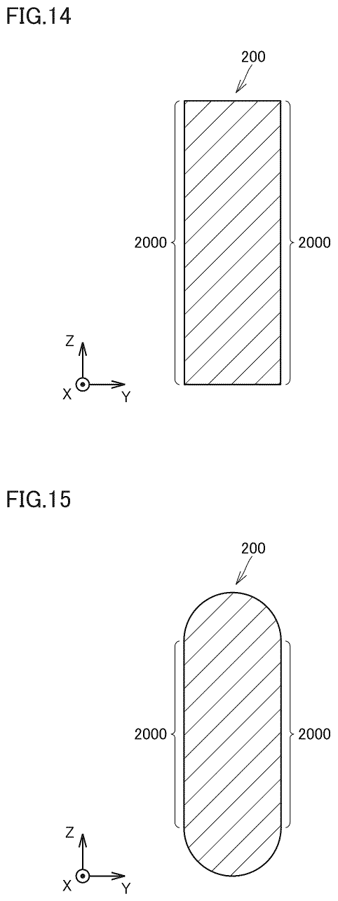

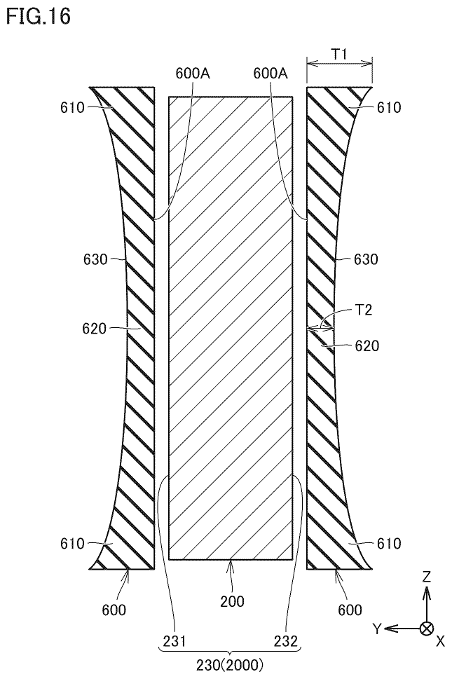

As shown in FIG. 16, electrode assembly 200 has a pair of main surfaces 230. Each of main surfaces 230 extends in a direction orthogonal to the Y direction. Spacers 600 are provided on both sides with respect to electrode assembly 200 in the Y direction. Each of spacers 600 is a plate-shaped member having an insulating property. Spacer 600 is accommodated in case 100 together with electrode assembly 200. Spacer 600 may be provided only on one side with respect to electrode assembly 200 in the Y direction.

Electrode assembly 200 shown in FIG. 16 is assumed to be the stacked type electrode assembly, and main surface 230 corresponds to flat surface 2000. When electrode assembly 200 is the wound type electrode assembly, its portion at which flat surface 2000 is formed corresponds to electrode assembly 200 shown in FIG. 16.

Spacer 600 has a flat surface 600A facing main surface 230. In the example of FIG. 16, flat surface 600A of spacer 600 on the left side in the figure faces a main surface 231 of electrode assembly 200 on the left side, and flat surface 600A of spacer 600 on the right side in the figure faces a main surface 232 of electrode assembly 200 on the right side.

Spacer 600 is composed of an insulating material. Preferably, spacer 600 is composed of a resin. As the resin of spacer 600, for example, polyethylene, polypropylene, or a resin having elasticity comparable to that of each of them can be used. Spacer 600 may be composed of a resin tape, a cut resin sheet, or the like.

Spacer 600 can be positioned by fixing flat surface 600A of spacer 600 to electrode assembly 200 or an electrode assembly holder (insulating member) provided outside electrode assembly 200. As a method of fixing spacer 600 to electrode assembly 200 or the electrode assembly holder, for example, it is possible to employ adhesion by a tape, adhesion by an adhesive agent, or welding such as thermal welding or ultrasonic welding.

Spacer 600 has: first portions 610 located on both end sides thereof in the Z direction; and a second portion 620 located on the center side thereof in the Z direction. Second portion 620 is located between the pair of first portions 610 in the Z direction (second direction). The thickness (first thickness) of each of first portions 610 in the Y direction is larger than the thickness (second thickness) of second portion 620 in the Y direction.

In the example of FIG. 16, a recess 630 having an arc shape is formed between first portions 610 located on the both end sides thereof in the Z direction, thereby forming second portion 620 having the relatively smaller thickness than that of first portion 610. Recess 630 is formed in the surface opposite to flat surface 600A. Flat surface 600A is formed continuously from one (first portion 610 on the upper side in the figure) of the pair of first portions 610 formed on both the end sides thereof in the Z direction to the other (first portion 610 on the lower side in the figure) thereof.

The maximum thickness (T1) of each of first portions 610 is preferably larger than the minimum thickness (T2) of second portion 620 by about 0.5 mm or more. The maximum thickness (T1) of first portion 610 is preferably about 2.5 mm or less, and more preferably about 1.5 mm or less. By setting the maximum thickness of first portion 610 to be equal to or more than the predetermined value, it is possible to increase the effect of suppressing the precipitation of metal as described later. By setting the maximum thickness of first portion 610 to be equal to or less than the predetermined value, it is possible to suppress decreased space efficiency in case 100.

The minimum thickness (T2) of second portion 620 is preferably about 0.05 mm or more and about 0.5 mm or less, and is more preferably about 0.1 mm. By setting the minimum thickness of second portion 620 to be equal to or more than the predetermined value, it is possible to secure the strength of spacer 600. By setting the minimum thickness of second portion 620 to be equal to or less than the predetermined value, it is possible to suppress decreased space efficiency in case 100.

However, the thicknesses of first portion 610 and second portion 620 are not limited to the above-described ranges.

Spacer 600 preferably has a cross sectional shape shown in FIG. 16 in its entire region in the X direction (first direction). However, spacer 600 may have a cross sectional shape partially different from that of FIG. 16 in the X direction. Preferably, at least in the central portion of spacer 600 in the X direction, the thickness of first portion 610 is larger than the thickness of second portion 620.

In the example of FIG. 16, spacer 600 is formed to be longer than electrode assembly 200 in the Z direction, and reaches outside of electrode assembly 200 in the Z direction. In this way, even when electrode assembly 200 is slightly moved in the Z direction in case 100, first portion 610 of spacer 600 and electrode assembly 200 can be securely overlapped with each other. When electrode assembly 200 is the stacked type electrode assembly, spacer 600 may reach the outside of electrode assembly 200 by, for example, about 2.5 mm upward and downward in the Z direction. However, spacer 600 may be provided in the same region as electrode assembly 200 in the Z direction, or may be formed slightly shorter than electrode assembly 200 in the Z direction.

As shown in FIGS. 17 to 19, the cross sectional shape of spacer 600 may be appropriately changed. First portion 610 preferably has a shape (for example, a straight tapered shape or an arc shape) that becomes thinner toward the central portion in the Z direction, but the thickness of first portion 610 may be substantially unchanged.

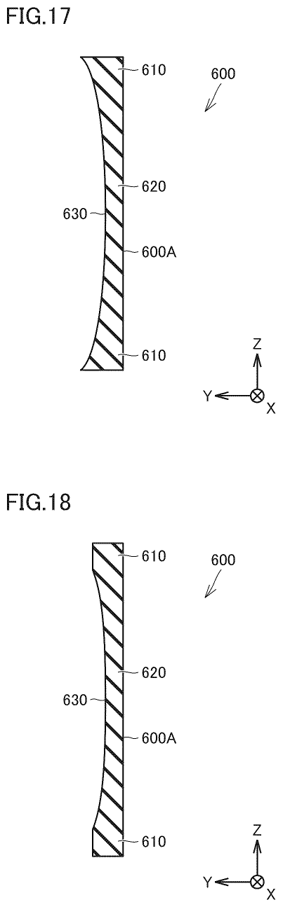

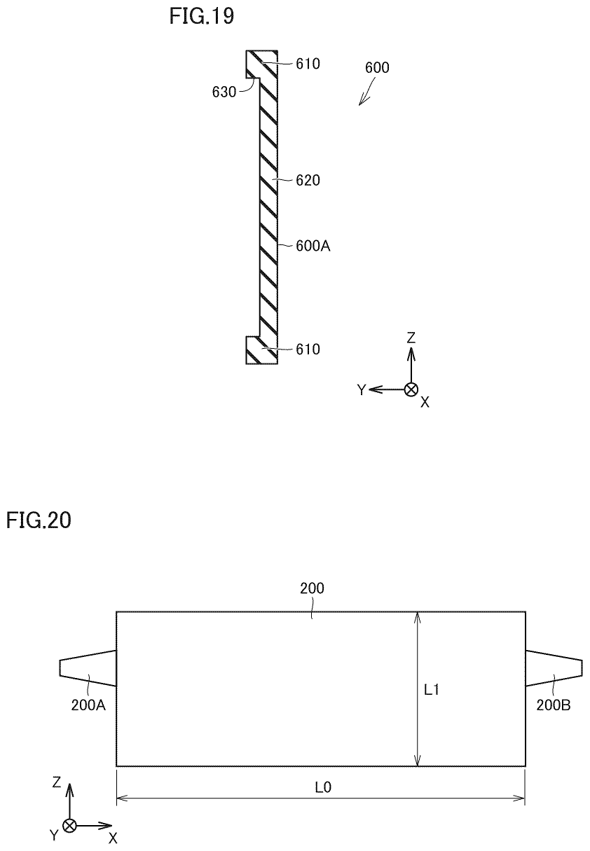

Specifically, there may be employed a cross sectional shape in which recess 630 having an arc shape is provided across the entire region thereof in the Z direction as shown in FIG. 17, or a cross sectional shape in which the thickness of first portion 610 of spacer 600 is substantially unchanged at the end portion thereof in the Z direction as shown in FIG. 18. As shown in FIG. 19, there may be employed a cross sectional shape with recess 630 having a substantially rectangular shape.

Next, a size relation between electrode assembly 200 and spacer 600 will be described with reference to FIGS. 20 to 22.

In FIGS. 20 to 22, as with FIG. 16, it is assumed that electrode assembly 200 is the stacked type electrode assembly. When electrode assembly 200 is the wound type electrode assembly, its portion at which flat surface 2000 is formed corresponds to electrode assembly 200 shown in FIGS. 20 to 22.

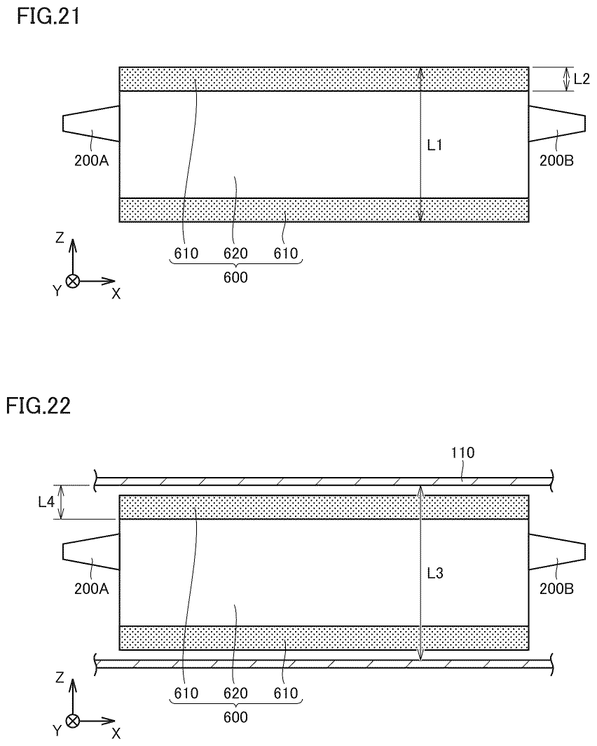

Moreover, in FIGS. 21 and 22, first portion 610 corresponds to a region having a thickness larger than the minimum thickness of second portion 620 by 0.5 mm or more.

As shown in FIG. 20, a main body portion (a rectangular portion other than negative electrode tab group 200A and positive electrode tab group 200B) of electrode assembly 200 has a shape in which a size (L0) in the X direction is larger than a size (L1) in the Z direction. For example, L0 is about 250 mm or more and 300 mm or less, and L1 is about 80 mm or more and 90 mm or less. The thickness (size in the Y direction) of electrode assembly 200 is about 20 mm or more and 40 mm or less. Further, a size ratio (L0/L1) between the X direction and the Z direction is, for example, about 1.5 or more, about 2 or more, or about 3 or more. L0/L1 is, for example, about 30 or less, about 10 or less, or about 5 or less. However, the sizes of electrode assembly 200 are not limited to the above ranges.

As shown in FIG. 21, first portion 610 is preferably formed to be overlapped with electrode assembly 200 at a region extending in the form of a strip in the X direction. A size (L2), in the Z direction, of the region in which the flat portion of electrode assembly 200 and first portion 610 are overlapped is preferably about 1/10 or more, and more preferably about ⅛ or more, of the size (L1) of electrode assembly 200 in the Z direction. L2 is preferably about ¼ or less of L1. However, the relation between L1 and L2 is not limited to the above range.

As shown in FIG. 22, electrode assembly 200 preferably has slight clearances between electrode assembly 200 and the inner surfaces of case main body 110 in the Z direction. In FIG. 22, it is assumed that the clearances in the upward/downward direction in the figure are equal to each other. Here, a size (L4) from the inner surface of case main body 110 to the end portion (center side in the Z direction) of first portion 610 in the Z direction is preferably about 1/10 or more, and more preferably about ⅛ or more, of the size (L3) of the inner space of case main body 110 in the Z direction. L4 is preferably about ¼ or less of L3. However, the relation between L3 and L4 is not limited to the above range.

In each of the examples of FIGS. 21 and 22, for convenience of illustration, the sizes of electrode assembly 200 and spacer 600 are the same, but spacer 600 may be formed to be shorter or longer than electrode assembly 200 in the X direction or the Z direction. In each of FIGS. 21 and 22, only a region of first portion 610 overlapped with electrode assembly 200 (flat surface 2000) is shown.

When forming a battery assembly by restraining, in the Y direction, case 100 having a prismatic shape, a pressure load is likely to be relatively small particularly in the vicinity of first end side 101. When variation in potential within positive electrode plate 220 of electrode assembly 200 occurs due to variation in the pressure load, the precipitation of metal (precipitation of lithium in a lithium ion battery) may occur.

To address this, in secondary battery 1 according to the present embodiment, since the thickness of spacer 600 is made relatively large at first portions 610 located on the both end sides thereof in the Z direction, it is possible to suppress decreased pressure load in the vicinity of first end side 101 of case main body 110. Therefore, the precipitation of lithium (precipitation of metal) can be effectively suppressed at the portion at which the pressure load is likely to be relatively small.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly having a pair of main surfaces;
a spacer having a flat surface facing one of the pair of main surfaces; and
an exterior container that has a prismatic shape and that accommodates the electrode assembly and the spacer, wherein the exterior container has a pair of first surfaces respectively facing the pair of main surfaces, a pair of second surfaces substantially orthogonal to the first surfaces, and a pair of third surfaces substantially orthogonal to the first surfaces and the second surfaces, and an area of each of the first surfaces is larger than each of an area of each of the second surfaces and an area of each of the third surfaces,
the first surface has a substantially rectangular shape including a pair of first end sides each extending in a first direction and a pair of second end sides each extending in a second direction substantially orthogonal to the first direction, and the pair of first end sides are longer than the pair of second end sides,
the spacer has a pair of first portions located on both end sides of the spacer in the second direction, and a second portion located between the pair of first portions in the second direction,
the flat surface of the spacer is formed continuously from one of the pair of first portions to the other of the pair of first portions, and
at least a portion of each of the pair of first portions in the first direction has a larger thickness than a thickness of the second portion in a direction orthogonal to the flat surface.

2. The secondary battery according to claim 1, wherein at least a central portion of each of the pair of first portions in the first direction has a larger thickness than the thickness of the second portion in the direction orthogonal to the flat surface.

3. The secondary battery according to claim 1, wherein an entire region of each of the pair of first portions in the first direction has a larger thickness than the thickness of the second portion in the direction orthogonal to the flat surface.

4. The secondary battery according to claim 1, wherein the spacer reaches outside of the electrode assembly in the second direction.

5. The secondary battery according to claim 1, further comprising an insulating member provided outside the electrode assembly.

6. The secondary battery according to claim 1, wherein
an entire region of each of the pair of first portions in the first direction has a larger thickness than the thickness of the second portion in the direction orthogonal to the flat surface, and
the spacer reaches outside of the electrode assembly in the second direction,
the secondary battery further comprising an insulating member provided outside the electrode assembly.

7. A battery assembly comprising:
a plurality of the secondary batteries according to claim 6, the plurality of the secondary batteries being arranged side by side in a third direction orthogonal to the first direction and the second direction; and
an inter-cell separator provided between the plurality of the secondary batteries, wherein
an area of the inter-cell separator is smaller than an area of each of the first surfaces of the exterior container as viewed in the third direction.

8. A battery assembly comprising:
a plurality of the secondary batteries according to claim 1, the plurality of the secondary batteries being arranged side by side in a third direction orthogonal to the first direction and the second direction; and
an inter-cell separator provided between the plurality of the secondary batteries, wherein
an area of the inter-cell separator is smaller than an area of each of the first surfaces of the exterior container as viewed in the third direction.
